(19) United States
(12) Patent Application Publication
(10) Pub. No.: US 2003/0202120 A1
(43) Pub. Date: Oct. 30, 2003

(54) Virtual lighting system

(76) Inventor: Newton Eliot Mack, Somerville, MA (US)

Correspondence Address: Newton Eliot Mack, 115 Elm Street #2, Somerville, MA, 02144, US

(21) Appl. No.: 10/117,577

(22) Filed: Apr. 5, 2002

(51) Int. Cl. H04N 15/00

(52) U.S. Cl. 348/578; 348/51

(57) ABSTRACT

The 3D position of a subject being recorded for film, video, or digital media creation may be recorded using an inexpensive 3D distance measuring system and recorder attached to a 2D film, video, or digital camera and used to create high quality composite images. The 3D information is used to generate a virtual camera and 3D geometry representing the subject in a virtual scene using a commercial 3D graphics software package. Color keying technology is used to separate the live action subject from the studio background. The live action subject images are projected onto the 3D geometry in the virtual scene. When the virtual scene is rendered, the virtual lights in the scene affect the 3D geometry representing the subject and a composite picture with integrated lighting is created.

### FIELD OF THE INVENTION

The invention relates generally to special effects filmmaking and more specifically to equipment and methods for sensing and recording various information including the camera's position and orientation, the distance from the camera to the various points of the subject, and the use of this information in generating high quality composite images.

### BACKGROUND TO THE INVENTION

Composite shots created by placing a performer in front of a blue or green background, removing the background, and inserting this image into a synthetic background have been used in motion picture and television production for many years. This process allows background sets to be used in production that are difficult or expensive to fabricate physically. These backgrounds can be comprised of miniature sets, matte paintings, or computer generated images. The focus of this idea is on the integration of keyed performers into computer generated backgrounds.

The principal difficulty with combining live action actors and computer generated backgrounds is the matching of the lighting and shadow casting conditions used on the keyed performer to the lighting and shadows used on the synthetic or virtual background. Failure to do this properly is immediately noticeable and breaks the suspension of disbelief of the audience. Currently, this matching is typically done by a very laborious process of manually matching virtual lights to the real lights used in principal photography. The absence of comparable controls and parameters in virtual lights and real lights makes this very difficult to achieve¹, especially as a low cost solution.

### DESCRIPTION OF PRIOR ART

Several systems have been developed in an effort to answer some of the above difficulties. The 3DV Systems ZCAM, described in patent EP00886790A2 and EP00835460A2, comes the closest to solving the problem. This system uses a pulsed illumination source and sensor, calculating time of flight reponse to measure distance; then generates a mesh in a CAD package and maps the image onto the mesh. This is the system that is the most similar to the object of the invention. Virtual lights affecting 3D geometry and casting shadows have been demonstrated². This system generates geometry that corresponds to the subject's body and allows virtual lights to affect the subject. However, it does not have the ability to position the subject geometry from simple optical markers, and requires an external camera tracking system. It also requires the use of a modified video camera, which precludes film use. It depends upon a pulsed infrared source, which reflects poorly from dark objects, limiting the system's flexibility. Finally, the system is very expensive due to the use of expensive high speed electronics to measure and compute the depth image at 30 frames per second; a 1999 cost estimate for a system exceeded $100,000 US.

Another system that addresses the problem is a prototype research system developed by Carnegie Mellon University³. This system is comprised of a 4 camera stereo vision machine that generates a depth map, which is then integrated with the 3D virtual set background in real time. Virtual lights affecting the subject, occlusion, and shadowing have been demonstrated. However, the output of the system is not suitable for most broadcast or content creation purposes. The lack of color keying technology to separate the live action foreground from the background causes the edges of the subject to be very rough and ragged. The system can not be integrated into a commercial film or video camera. It does not have the ability to position the subject geometry using optical markers for a complete virtual set solution. Finally, the real time lighting used does not allow computationally intensive algorithms for high quality light effects to be used.

The Accom/Orad EL-SET solves the subject position in perhaps the most direct way, by giving the keyed subject a depth value during the performance generated by an operator observing the show and manually shifting the depth to occlude objects correctly⁴. This solution is inexpensive and simple, but requires an attentive operator! Furthermore, the system does not allow for accurate shadow casting on the subject or the background. There is also no provision for automatic matching of the key lighting to the background lighting.

U.S. Pat. No. 5,737,031 uses a second camera located and oriented in the same direction as the desired virtual light. The image seen by the second camera is then used to create a projected shadow in the virtual environment. This creates an accurate shadow of the performer in the virtual background, but does not allow lights in the virtual background to affect the keyed subject, compromising image integration. Furthermore, the system requires a video camera to be placed in any position a light would be placed in the virtual set, which becomes expensive rapidly.

No current system exists that achieves the goal of high quality virtual set scene generation with automatic matching of lighting between subject and background at a low cost.

Prior art of the various components of the invention includes:

Camera tracking systems, both external and image marker based

Stereo vision 3D depth data capturing and recording technology

Computer based lighting and rendering algorithms

Color keying technologies to remove studio backgrounds from live action images

### SUMMARY OF THE INVENTION

The virtual lighting system solves this problem. During principal photography in front of a blue, green, or other color background, a stereo vision system attached to the film, video, or digital camera records the distance from the camera to all portions of the subject that the camera can see (referred to as the depth data). The acquisition of the depth data can be synchronized with the individual frames of the video or film camera through time code created by the 2D camera and read by a host computer. The position of the camera is recorded during shooting, either by visible fixed reference points in the camera's field of view, or by an external camera position recording device.

The system is designed to be used with any existing film or video camera without special modifications other than the attachment of the stereo vision head. The stereo images are recorded on a computer hard drive to allow inexpensive, accurate post processing (processing after shooting is completed) of the depth data instead of costly and relatively inaccurate real time processing during recording. The use of stereo vision to generate the 3D geometry can recognize dark hair, skin, or clothing that infrared based depth systems have difficulty illuminating. The system uses inexpensive off the shelf hardware, stereo vision, and cameras to lower the system's cost to approximately 1/10 of other commercial systems, and is lightweight and compact enough for handheld or Steadicam use.

A digital model of the desired background set is constructed inside a computer. The motion, orientation, and field of view of the virtual camera in the virtual set is generated from visible reference points in the 2D footage or from an external recording mechanism to match the movement of the real camera. A planar mesh with an aspect ratio that matches the 2D images is constructed at a distance from the virtual camera determined by the information in the depth data or manually measured during photography. This mesh is then deformed out of the plane of the mesh toward and away from the camera based upon the depth data. The 2D images are keyed with any of a number of standard algorithms to remove the studio background while maintaining fine details of the subject, such as hair or rapid motion.

This use of color keying technology for subject separation is a fundamental improvement over most other systems that attempt to use the depth data to separate the subject from the background. Color keying technology is very well developed, with many industry standard methods to achieve very intricate resolution of fine details of the subject. The use of depth data to separate the subject typically results in a coarse subject edge that is unacceptable for the production of high quality composite images.

Next, the keyed 2D image from the television or film camera used in the principal photography is projected from the camera's point of view onto the displaced mesh to create a 3D virtual reconstruction of the actor. Finally, the entire scene, including the background and foreground, is rendered by the same computer lighting and rendering algorithms. In this way, physically accurate lighting of both the actor and the background is achieved automatically, with no need for tedious manual matching of foreground and background. In essence, the problem of lighting during principal photography is reduced to simply lighting subject details.

The main problem that is solved with this technique is the extremely high effort and cost currently required to integrate live action footage and virtual backgrounds using complex lighting. The construction of a system that can capture all of the required information, perform all the necessary calculations, and generate visual output at a low cost is a significant advancement. Savings are achieved in two ways: lowering the labor and infrastructure costs of operating, moving, and powering the physical lights, and lowering the labor costs required to hand match the virtual lights.

For labor cost savings to be truly effective, however, the system costs must be low as well. Previous systems that perform similar tasks have very high hardware costs due to their real time processing of depth information. By recording the raw stereo video data using an inexpensive stereo camera system and then post processing it after the initial recording, low cost and high performance is achieved.

There are several other problems that are resolved by this system as well. Lighting decisions on the live talent are no longer final after principal photography has been undertaken. As the light sources are virtual, they can be moved around, adjusted, or otherwise corrected and the final product rerendered.

The use of computer generated lighting algorithms allows for much more flexibility in the lighting than can be obtained with traditional lighting fixtures and rigging. Light can be added, deleted, adjusted, or moved in ways that would be impossible with normal physical lights.

A fundamental possibility enabled by this system is that the lighting during principal photography can also be considerably simplified. The removal of the need for many of the physical lighting tools such as stands, lights, flags, masks, etc. as well as the people required to operate them represents an enormous potential reduction in the cost of filmmaking. This is potentially the biggest application of the system with the furthest reaching implications.

The use of physical lights to illuminate bluescreen shots has limited them to composite shots set indoors or in artificially lighted environments, due to the difficulty of matching a sunlit background to an artificially lit foreground. Since the proposed system allows the use of computer generated ‘outdoor’ lighting, outdoor shots that would have required shooting on location could be achieved in the studio at a much lower cost.

Finally, the system is portable enough to be useful in a wide variety of camera situations, including handheld, Steadicam, dolly and crane mountings.

There has never been an invention that inexpensively gathers the subject's position depth in sufficient detail to enable 3D lighting effects and allow compositing of the subject's image in a computer generated background with the background lighting automatically and accurately affecting the subject.

Objects and Advantages

Accordingly, several objects and advantages of my invention are:

a) To provide a virtual lighting system that enables automatic matching of keyed foreground and virtual background images;

b) To provide a virtual lighting system that accurately measures and records the position of the camera and the distance from the camera to all points on the subject being recorded;

c) to provide a virtual lighting system that is easily portable;

d) to provide a virtual lighting system that is inexpensive;

e) to provide a virtual lighting system that allows changing the lighting of a scene in post production;

f) to provide a virtual lighting system that allows simplification of physical lighting systems used in production;

g) to provide a virtual lighting system that can achieve lighting effects in the virtual world that would be difficult or impossible to achieve with physical lights, such as removal of light from an area, pyrotechnic effects very close to performers, etc.;

h) to provide a virtual lighting system that can be operated in or out of doors;

i) to provide a virtual lighting system that does not require a dedicated studio installation;

j) to provide a virtual lighting system that does not depend on 2D lens optical characteristics to measure subject distance;

k) to provide a virtual lighting system that does not need to be preprogrammed for a given camera path;

l) to provide a virtual lighting system in which the distance to the subject does not have to be predetermined before shooting;

m) to provide a virtual lighting system that does not require special equipment to be placed on the subject;

n) to provide a virtual lighting system that can maintain accuracy in a variety of ambient conditions;

o) to provide a virtual lighting system that can be used in conjunction with a Steadicam or similar camera steadying apparatus for use in rugged environments;

p) to provide a virtual lighting system that can be powered using a small battery easily carried by the camera operator

q) to provide a virtual lighting system that uses industry standard color keying technology to separate the live action subject from the studio background.

Further objects and advantages are to provide a virtual lighting system which can be used easily and conveniently to track a performer, which can be used repeatedly, which does not depend on expendables, and which is durable and rugged under the strains of filmmaking. Still further objects and advantages will become apparent from a consideration of the ensuing description and drawings.

### DRAWING FIGURES

FIG. 1 is an overall view of a depth data capture subsystem for measuring and recording the distance to all points on the subject attached to a standard film, video, or digital camera and used for video, digital, and film production of special effects sequences in a first embodiment of the present invention.

FIG. 2 is a flow chart describing the overall plan of a post processing system for removing the background from the 2D image and depth data, creating subject geometry in a 3D computer graphics software package, and rendering an integrated image using a live action subject and a synthetic background, both being affected by synthetic lights in a first embodiment of the present invention.

FIG. 3 is an unprocessed 2D image from the standard film, video, or digital camera of FIG. 1.

FIG. 4 is a 2D image from the standard film, video, or digital camera of FIG. 1 with a keyed background.

FIG. 5 is a processed depth map image from the depth map capture subsystem of FIG. 1 with background area removed using the background data from the keyed image of FIG. 4.

FIG. 6 is a diagram of a virtual camera with an undeformed planar mesh at a computed distance derived from the depth map capture subsystem of FIG. 1.

FIG. 6a is an undeformed mesh generated by the graphics program, showing the shape before application of the depth map generated by the depth map capture subsystem of FIG. 1.

FIG. 6b is a deformed mesh generated by the graphics program, showing the shape after application of the depth map generated by the depth map capture subsystem of FIG. 1.

FIG. 7 is a deformed mesh with a virtual light applied to it, showing the interactive effects of a virtual light applied to the keyed subject.

FIG. 7a is a rendered live action foreground using the background virtual lighting shown in FIG. 7.

FIG. 8 is a higher resolution composite with a live action key composited into a virtual background.

List of Reference Numerals

18 film, video, or digital 2D camera

20 depth capture subsystem

24 stereo vision system

26 rigid mount

28 portable computer

30 optional detachable storage

32 camera data interface

34 storage data interface

38 post processing subsystem

39 unprocessed 2D image

40 2D subject image

41 optical marker

42 keyed background

43 unkeyed background

44 keyed resized depth map

50 virtual camera

51 virtual camera path and parameters

52 planar mesh

53 virtual background

54 deformed mesh

55 3D graphics software package

56 deformed mesh with mapped 2D image, also called 3D subject geometry

60 virtual light

70 rendered composite

72 rendered high resolution composite

### SUMMARY

Briefly, an embodiment of the present invention compromises a stereo vision system attached to a film, video, or digital 2D camera and connected via a data interface to a computer and a post processing subsystem to integrate the 2D, 3D, and virtual background data and create matched composite images. The camera may be hand held, mounted on a stabilizing platform, dolly, crane, or other vehicle. The stereo vision system records the raw depth data from the subject that the standard camera is pointing at and records the data on a computer or on a portable storage device attached to the computer. The raw depth data files are converted to gray scale depth map images in the post processing system. The 2D image sequence is keyed to remove its background and the keying information used to remove the background from the depth map image sequence. A 3D modeling and animation package is used to generate the virtual background in which a virtual camera is placed and oriented using data from optical trackers in the 2D footage. The depth map is used to create deformed mesh geometry that represents the subject in the virtual scene. The keyed 2D footage is then projected onto the deformed mesh to create a virtual subject inside the virtual set and the entire scene rendered in the computer to create a finished matched composite.

### DESCRIPTION OF FIGURES

A typical system of use is comprised of two main subsystems: a 3D depth capture subsystem 20, and a post processing subsystem 38 which are detailed below.

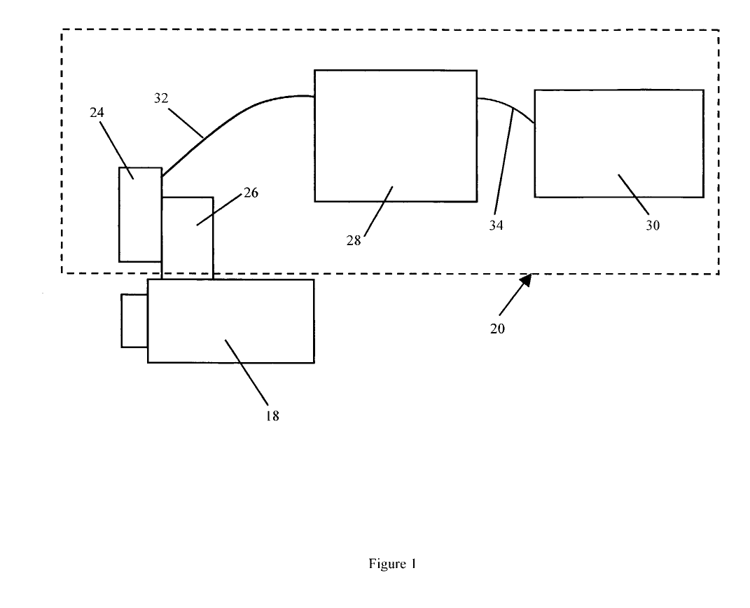

FIG. 1 illustrates the overall construction of 3D depth capture and recording subsystem 20 for logging the position, orientation, and subject distance of a camera for video and film production of special effects sequences in a first embodiment of the present invention. This subsystem consists of two main components, a stereo vision system 24 and a computer 28. Stereo vision system 24 is mounted rigidly to a standard film, video or digital camera 18 by a rigid mount 26. The preferred embodiment of stereo vision system 24 is the Digiclops portable system made by Point Grey Research of Vancouver, British Colombia, Canada. Stereo vision system 24 is connected to computer 28 via a camera data transfer interface 32. This can be wireless or use a wire, and can transmit analog or digital data. The preferred embodiment is a high bandwidth digital connection using a flexible wired IEEE 1394 digital interface. Computer 28 is a standard portable or desktop computer with an interface to stereo vision system 24 and sufficient storage to hold the large data files generated. Optionally, computer 28 may have a detachable storage system 30 that allows for more convenient data storage and transfer. The preferred embodiment of data storage 30 is a portable high speed hard drive RAID array that connects to computer 28 using the same high speed IEEE 1394 digital data interface. The stream of images can be captured directly to a hard disk using commercially available software written for the Digiclops system. The preferred embodiment of the capture software is the standard Digiclops streaming capture library available from Point Grey Research.

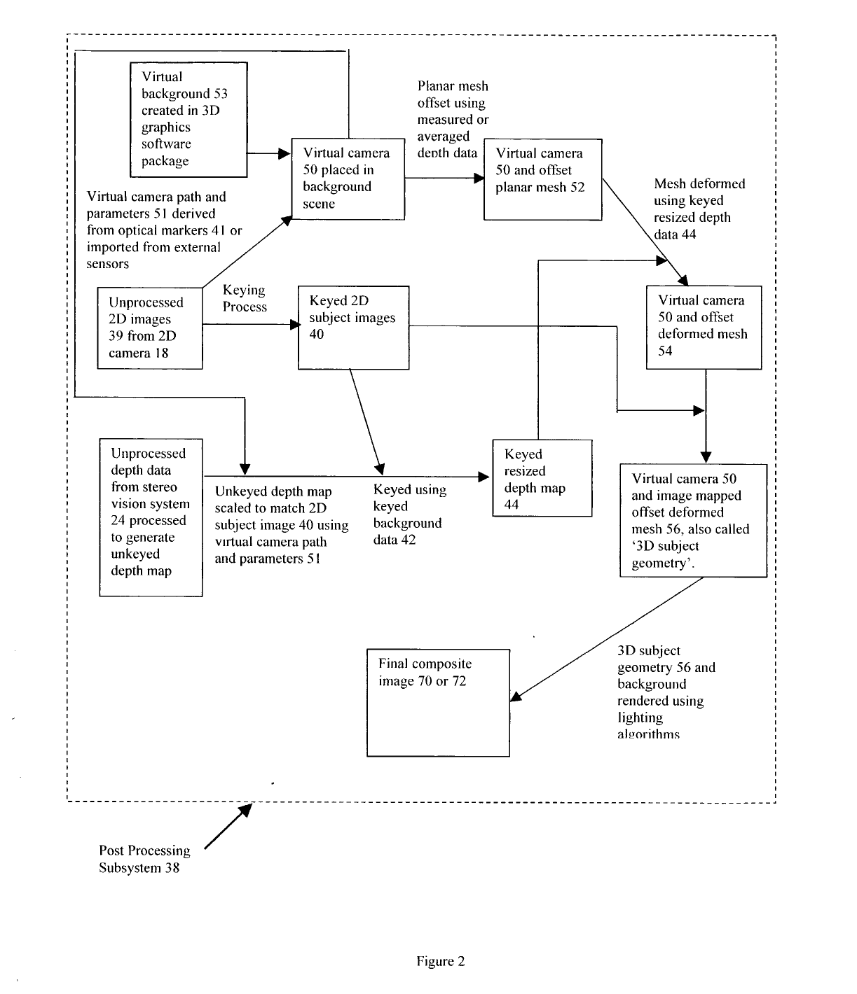

FIG. 2 shows a flowchart layout of a post processing subsystem process sequence.

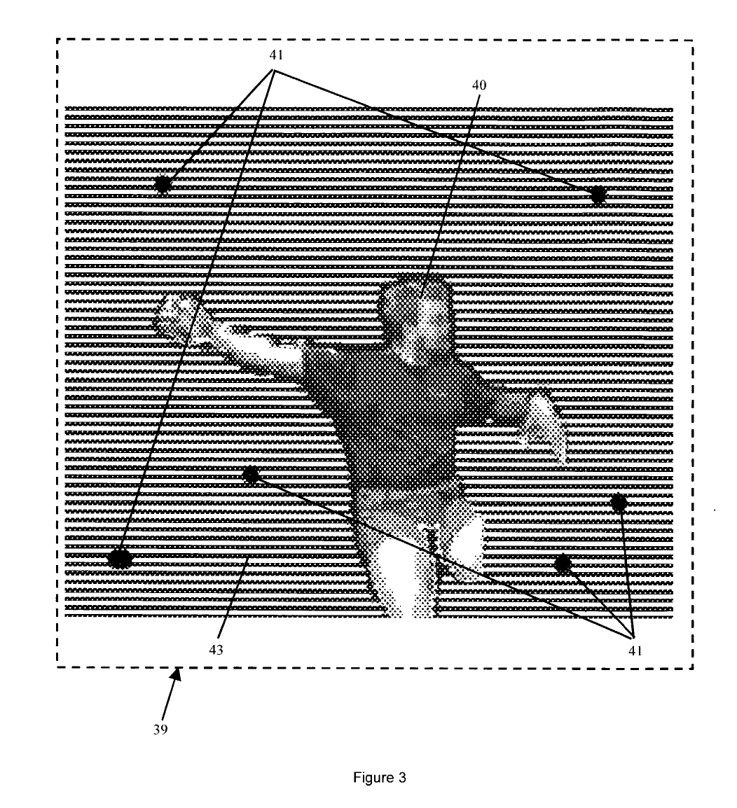

FIG. 3 illustrates a single unprocessed 2D image 39 from a piece of footage captured by camera 18 during a shot. The frame consists of a 2D subject image 40 and an unkeyed background 43 optionally containing optical markers 41. Optical markers 41 are used by a 3D graphics software package to compute the position of virtual camera 50 as well as a camera path and parameters 51.

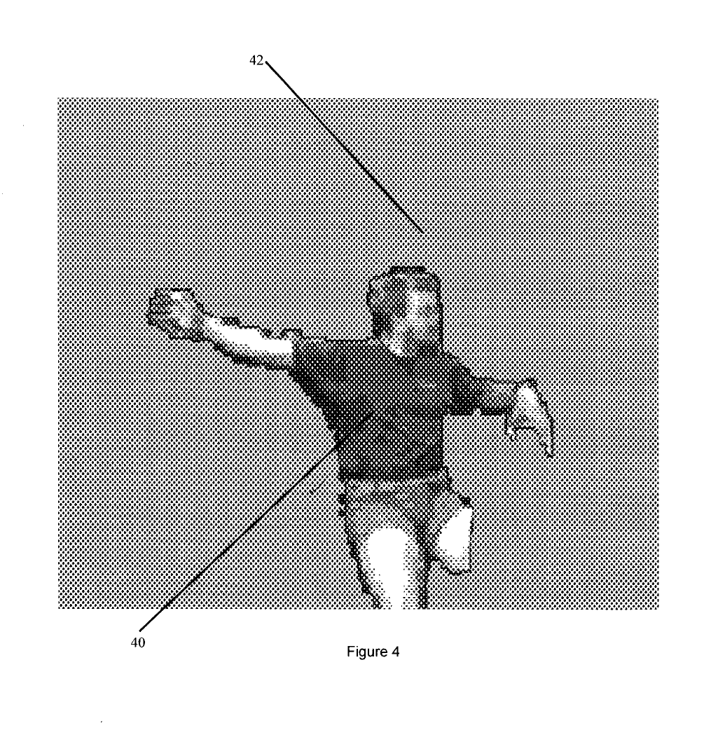

FIG. 4 illustrates a single 2D frame in which background 43 has been removed from 2D subject image 40 using a keying process, resulting in an image consisting of 2D subject image 40 and a keyed background 42. ‘Keying’ is a general industry term for removing the background of a shot; blue and green screen keying, depth keying, rotoscoping, and many other methods of separating the subject of a shot from the background may also be used. The preferred embodiment is blue or green screen keying, typically in conjunction with some rotoscoping work to manually ‘clean up’ the edges of the resulting keys. This is typically done using a commercial software package developed for this application; the preferred embodiment is the compositing software Commotion made by Pinnacle Systems Inc. of Mountain View, Calif., USA.

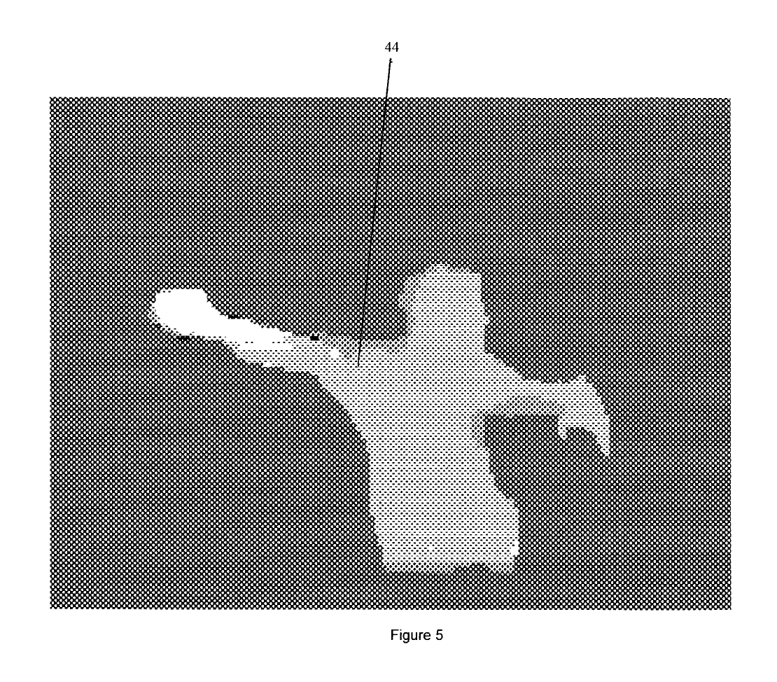

FIG. 5 illustrates a grey scale depth map 44 with the background removed using information from keyed background 42. Depth map 44 can be generated as the shot is recorded or processed later. The preferred embodiment of the depth map uses software techniques developed by Point Grey Research, the manufacturer of the preferred stereo vision system, to process the raw depth data after the shooting has been completed. This technique uses computationally expensive algorithms for more accurate measurement and more careful control of the depth map generation process. The code to achieve this grey scale computation, called ‘mapimage’, is listed in Appendix A. The processing results in a grey scale depth map 44, with closer regions of the subject showing up as lighter portions of the depth map.

To transfer the most detailed depth information from the raw depth data to the grey scale depth map, the distance of the rearmost portion of the live action subject should correspond to a black color on the depth map. The distance of the frontmost portion of the subject should correspond to a white color on the depth map. The mapimage program uses as input the distance from the subject to camera 18 at various points of a given image sequence and the thickness of the subject. The subject distance measurements are typically already being taken to accurately set focus of the camera. The subject thickness measurement can be adjusted to generate the most detailed depth map depending on the subject's size and activity.

As the lenses on stereo vision system 24 are fixed focal length in the preferred embodiment, the size of the grey scale depth map must be adjusted to match the size of 2D subject image 40. 2D subject image 40 is typically generated by a camera with a field of view different from the stereo vision system. This scaling can be done in many commercial software packages; in the preferred embodiment it is also completed in Commotion. The scaling is completed in the preferred embodiment using data from the virtual camera path and parameters 51.

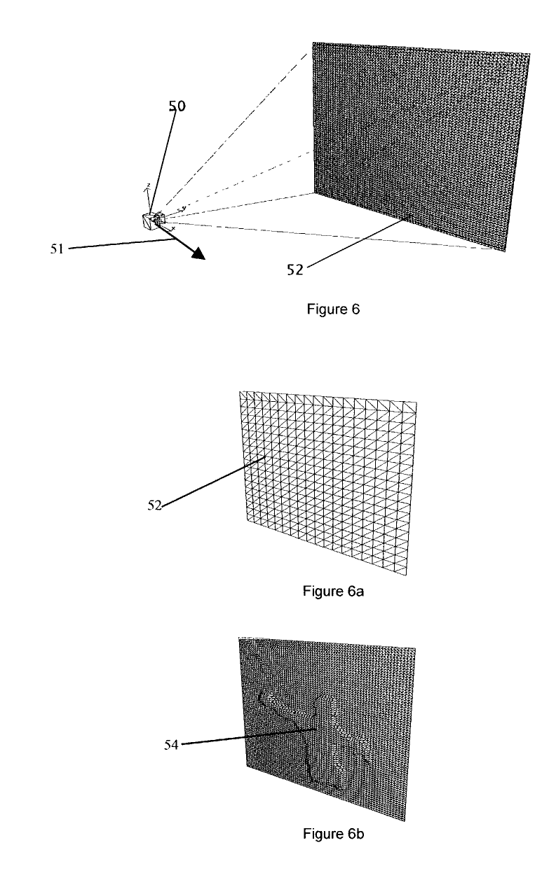

FIG. 6 illustrates a virtual camera 50 with a planar mesh 52 offset in a direction normal to the camera axis and at a distance computed from depth map 44 or specified using the manually measured distances from the subject. The preferred embodiment uses the same manually measured distances to the subject obtained during principal photography and used as inputs to the mapimage software. Virtual camera 50 is created and positioned within the 3D animation software using any of a variety of standard techniques for camera tracking, including optical markers, external camera sensors, and hand matching. The preferred embodiment is the use of optical markers 41 embedded in unkeyed background 43 for speed and simplicity. The preferred embodiment of the 3D graphics software containing camera tracking utilities is Match Mover made by Realviz Inc. of San Francisco, Calif. The preferred embodiment of the 3D graphics software used for rendering is Universe, made by Electric Image of San Clemente, Calif.

FIG. 6a is a closer view of undeformed planar mesh 52 before depth map 44 is applied to it in the 3D software. FIG. 6b shows a deformed mesh 54 after grey scale depth map 44 is applied to planar mesh 52 in the 3D graphics program. The shade of depth map 44 is proportional to the distance from camera 18 to the portion of the subject in question. The preferred embodiment is for lighter portions of depth map 44 to cause more deformation in mesh 54, causing the mesh in that area to be closer to virtual camera 50. Depth map 44 is applied to mesh 52 using a ‘displacement map’ function, available in most commercial 3D graphics and animation packages. The preferred embodiment of this software is the aforementioned 3D Studio Max.

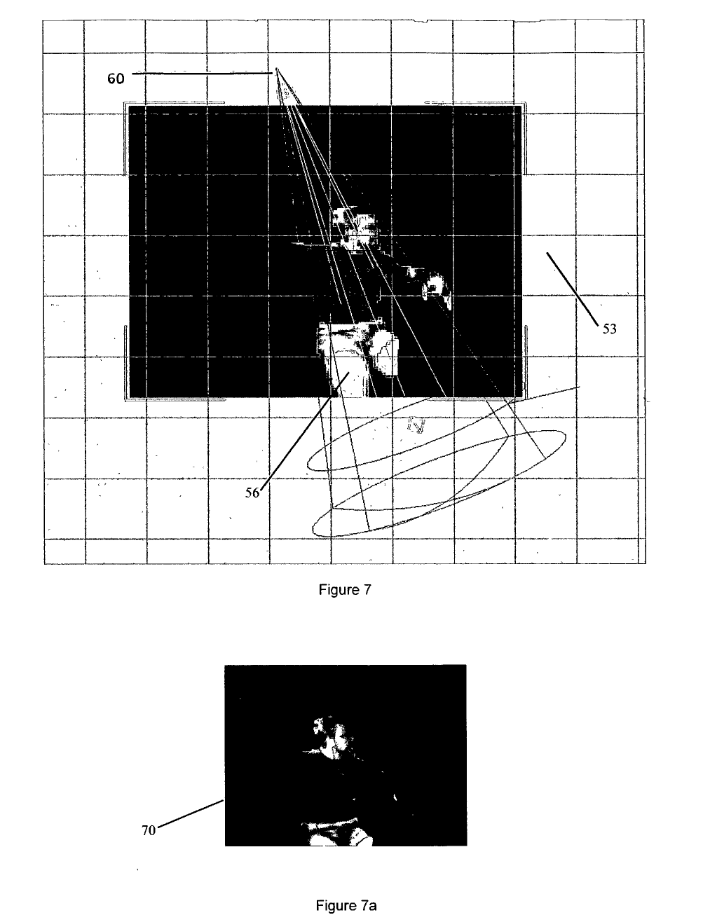

FIG. 7 shows deformed mesh 54 with keyed 2D image map 40 applied to it, creating 3D subject geometry 56. The image demonstrates the effects of virtual light 60 applied to 3D subject geometry 56. As the live action subject now has depth and thickness in the 3D graphics program, virtual light 60 is reflected from the subject realistically. This effect can only be approximated with traditional 2D compositing processes.

FIG. 7a is a completed rendered composite 70 using keyed foreground image 40 and virtual background light 60.

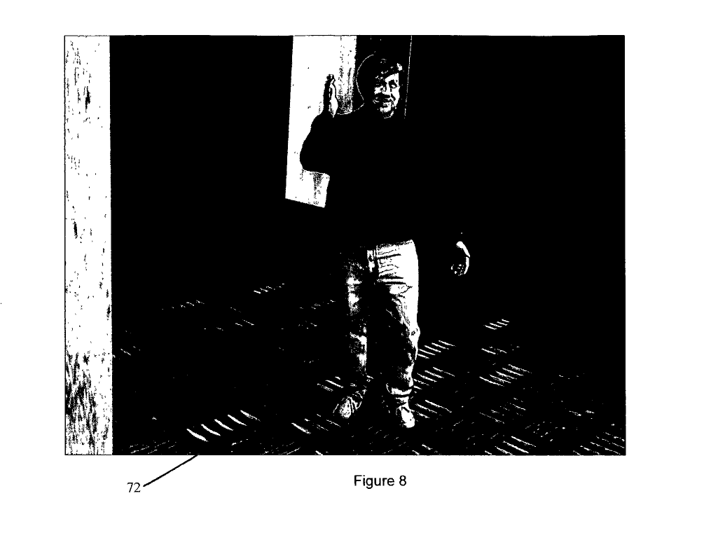

FIG. 8 shows a higher quality rendered composite 72 made with another subject and background.

Operation of Invention

A typical system of use is comprised of two major subsystems: a 3D depth capture subsystem 20, and a post processing subsystem 38. Depth capture subsystem 20 is composed of the following parts:

A stereo vision system 24

A host computer 28 to control the vision system

A camera data interface 32

A 2D film, digital, or video camera 18

A storage device 30 for the stream of unprocessed depth capture data

A storage data interface 34

The post processing subsystem is composed of the following parts:

A computer for all of the software to run on

Depth processing software to compute depth images from above raw depth data

Keying software to remove the backgrounds from the 2D footage

Commercially available 3D modeling and rendering software capable of performing the following tasks:

1. Generation of a camera path and parameters 51 from optical markers 41 or externally generated position data

2. Calculation of an offset distance for mesh plane 52 from keyed depth data (may also be input manually from measurements taken during photography)

3. Generation of a base mesh plane 52 normal to the axis of virtual camera 50 at the previously calculated offset distance for each frame of subject/camera movement

4. Animation of deformed mesh 54 based on depth image 44

5. Application of keyed 2D subject image 40 to displaced mesh 54

Lighting and rendering algorithms to produce rendered composite 70 and 72

3D Depth Capture Subsystem:

In normal operation, camera 18 is aimed at the subject and operated. Computer 28 captures a set of 3 images from stereo vision camera 24 that corresponds to each 2D footage frame 39 or a set of several frames. The preferred embodiment of the stereo vision camera is the Digiclops camera made by Point Grey Research of Vancouver, British Colombia, Canada. This raw depth data is stored digitally in the computer's memory or in an external storage system 30. The preferred embodiment is an external portable hard drive with a IEEE 1394 inteface that can be rapidly attached to different computers to facilitate transfer of the very large files involved in this process.

Capture and storage of the raw depth data and the 2D subject images can occur simultaneously with the use of a special stereo lens attached to a standard video camera⁶. This has the advantage of providing a depth map that has the same field of view as the 2D subject image as both are derived from the same lens source. The principal disadvantage of this system is that the artistic choice of lenses for the 2D images is drastically compromised, consisting only of available stereo lenses that can mount onto standard 2D cameras.

Capture of the raw depth data and the 2D subject images can also be achieved by using the image from one of the stereo vision camera lenses as the 2D image source. Commercially available inexpensive stereo vision systems do not typically have adjustable lenses or zooms as they depend upon the precise registration of the stereo lenses with respect to each other to maintain accuracy in the computation of the depth map. Thus, this solution is considered less desirable.

Post Processing Subsystem:

After the capture is completed, the raw depth data is processed to generate a depth image 44 that corresponds to a matching 2D film or video frame 39. The preferred embodiment uses standard software developed by Point Grey Research, the manufacturer of the preferred stereo vision system, to process the raw depth data after the shooting has been completed, using computationally expensive algorithms for more accurate measurement and more careful control of the depth map generation process. The code to achieve this grey scale computation, named ‘mapimage’, is listed in Appendix A. The processing results in a grey scale depth map, with closer regions of the subject showing up as lighter portions of the depth map.

To transfer the most detailed depth information from the raw depth data to the grey scale depth map, the distance of the rearmost portion of the subject should be correspond to a black color on the depth map. The distance of the frontmost portion of the subject should correspond to a white color on the depth map. The mapimage program uses as input the distance from the subject to the camera at various points of a given image sequence and the thickness of the subject. The subject distance measurements are typically taken to accurately set focus of the camera. The subject thickness measurement can be adjusted to generate the most detailed depth map depending on the subject's size and activity.

Unprocessed 2D image 39 is imported into a computer. Next, a virtual set background 53 is loaded into the 3D modeling software. A camera path and parameters 51 of a virtual camera 50 are generated using optical markers 41 in background 43 or input from an external file generated by an external camera tracking system. In the preferred embodiment, the distance from the actor to the camera obtained by direct measurement during principal photography is used to offset rectangular planar mesh 52 at the proper distance from virtual camera 50, as shown in FIG. 6. This distance can also be computed from the average distance of the keyed subject depth map to provide an automated solution.

As the lenses on stereo vision system 24 are fixed focal length in the preferred embodiment, the size of the grey scale depth map must be adjusted to match the size of 2D subject image 40, which is typically generated by a camera with a field of view that is not the same as the stereo vision system's. This scaling can be done in many commercial software packages; in the preferred embodiment it is also completed in Commotion. In the preferred embodiment, the scaling is determined from virtual camera parameters 51.

Unprocessed 2D image 39 is keyed to remove background 43 and create keyed image 40. A resulting keyed background area 42 is used as a pattern to erase the corresponding background portion of the depth image to create keyed resized depth map 44.

Depth image 44 is then applied to planar mesh 52 using a displacement map function in the 3D software package to create deformed mesh 54 which represents the proper 3D dimensions of the subject. This produces 3D geometry only of the front half of the foreground object. Possible variations of this include:

Mirroring the geometry and maps across the plane of the mesh

Creating a second mesh whose displacement is offset from the first mesh's by a constant, mathematically calculated, or user defined value

Creating holes or topological cuts in the mesh based on large disparities in object depth

The preferred embodiment is the deformed planar mesh due to its simplicity, ease of use, and sufficient performance for most images.

Keyed 2D subject image 40 is projected or mapped from the point of view of virtual camera 50 onto deformed mesh 54. This direction of projection hides the distortions of the 2D map from the viewpoint of virtual camera 50 as it is ‘wrapped’ onto deformed mesh 54.

After this is complete, virtual lights 60 and virtual background 53 are adjusted throughout the range of the shot to make sure that the proper effects are being achieved. As the lighting is instantly updated in the 3D graphics software, this is easy to troubleshoot and correct.

The entire sequence is then rendered, creating a rendered composite 70. This composite uses a live action foreground and a virtual background and automatically matches the lighting of the two parts. A higher quality version is shown in rendered composite 72.

Conclusion, Ramifications, and Scope of Invention

Thus, the reader will see that the virtual lighting system of the invention provides a highly portable, robust, accurate, practical method of recording subject depth data and creating integrated composite shots with matched subject and virtual lighting. The virtual lighting system has the additional advantages in that

Accordingly, several objects and advantages of my invention are:

a) It provides a virtual lighting system that enables automatic matching of keyed foregraound and virtual background;

b) It provides a virtual lighting system that accurately measures and records the position of the camera and the distance from the camera to all points on the subject being recorded;

c) It provides a virtual lighting system that is easily portable;

d) It provides a virtual lighting system that is inexpensive;

e) It provides a virtual lighting system that allows changing the lighting of a scene in post production;

f) It provides a virtual lighting system that allows simplification of physical lighting systems used in production;

g) It provides a virtual lighting system that can achieve lighting effects in the virtual world that would be difficult or impossible to achieve with physical lights, such as removal of light from an area, pyrotechnic effects very close to performers, etc.;

h) It provides a virtual lighting system that can be operated in or out of doors;

i) It provides a virtual lighting system that does not require a dedicated studio installation;

j) It provides a virtual lighting system that does not depend on known lens optical characteristics to measure subject distance;

k) It provides a virtual lighting system that does not need to be preprogrammed for a given camera path;

l) It provides a virtual lighting system in which the distance to the subject does not have to be predetermined before shooting;

m) It provides a virtual lighting system that does not require special equipment to be placed on the subject;

n) It provides a virtual lighting system that can maintain accuracy in a variety of ambient conditions,

o) It provides a virtual lighting system that can be used in conjunction with a Steadicam or similar camera steadying apparatus for use in rugged environments;

p) It provides a virtual lighting system that can be powered using a small battery easily carried by the camera operator

q) to provide a virtual lighting system that uses industry standard color keying technology to separate the live action subject from the studio background.

While my above description contains many specificities, these should not be construed as limitations on the scope of the invention, but rather as an exemplification of one preferred embodiment thereof. Many other variations are possible. For example, the depth map sensor can be infrared or laser based instead of using stereo vision. The data can be wirelessly transmitted from the camera to the storage system, or the storage system can be-mounted on the camera. Depth keying can be used instead of blue or green screen keying to separate the subject in the 2D footage from the background The location of the virtual camera in the 3D modeling software can be determined from an external camera measurement system instead of software based optical marker tracking.

Accordingly, the scope of the invention should be determined not by the embodiment(s) illustrated, but by the appended claims and their legal equivalents.

[image]

[image]

[image]

[image]

I claim:

1. Apparatus for creating composite images with matched lighting, said composite images consisting of computer generated and live action elements, comprising:
a) means for measuring and recording unprocessed subject depth data,
b) means for recording 2D images of said live action elements,
c) means for separation of said live action elements from a studio background using color keying technology,
d) means for post processing said depth data and said 2D images to create 3D subject geometry,
e) means for integrating said 3D subject geometry into a virtual background containing one or more virtual lights,
f) means for generating a final matched composite image in which said virtual lights affect both said 3D subject geometry and said virtual background,
whereby said matched composite images can be generated with little effort in comparison to standard techniques.

2. The apparatus of claim 1 wherein said means for measuring subject depth data is a stereo vision system.

3. The apparatus of claim 1 wherein said means of recording said depth data is a computer or mass storage device.

4. The apparatus of claim 1 wherein said means integrating said 3D subject geometry into said virtual background is a virtual camera path and parameters generated from visible markers in said 2D images.

5. The apparatus of claim 1 wherein said means of integrating said 3D subject geometry into said virtual background is a virtual camera path and parameters generated from an external camera position and orientation measuring device.

6. The apparatus of claim 1 wherein said means of measuring and recording said unprocessed depth data is a structured light based 3D scanning system.

7. The apparatus of claim 1 wherein said means of measuring and recording said unprocessed depth data and said means of recording 2D images of said live action elements is a stereo lens attached to a standard film, digital, or video camera.

8. The apparatus of claim 1 wherein said means of measuring and recording 2D images of said live action elements is the data from one of the stereo camera lenses.

9. A method of creating composite images with matched lighting, said composite images consisting of computer generated and live action images, comprising the steps of:
a) recording said 2D live action images and unprocessed subject depth data simultaneously,
b) deriving a virtual camera path and lens parameters from said 2D live action images,
c) removing the backgrounds of said 2D live action images using industry standard color keying techniques to create keyed 2D live action images,
d) processing said subject depth data to create a depth map,
e) scaling said depth map to match said 2D keyed live action images,
f) removing the background of said depth map using the background data from said 2D keyed live action images to create a keyed resized depth map,
g) creating 3D subject geometry using said keyed resized depth map and said 2D keyed live action images,
h) creating a virtual background containing one or more virtual lights in a 3D graphics software package,
i) integrating said 3D subject geometry in said virtual background using said virtual camera path and lens parameters,
j) generating a final matched composite image in which said virtual lights affect both said 3D subject geometry and said virtual background,
whereby said matched composite images can be generated with little effort in comparison to standard techniques.

10. The method of claim 9 wherein said method of measuring said unprocessed subject depth data is a stereo vision system.

11. The method of claim 9 wherein the method of generating 3D subject geometry is a combination of displacement mapping and image projection.

12. The method of claim 9 wherein background removal of said 2D live action images is augmented by manual rotoscoping.

13. The method of claim 9 wherein the method of recording said unprocessed subject data is a computer or mass storage device.

14. The method of claim 9 wherein the method of recording said unprocessed subject data and said 2D live action images is a stereo lens mounted on a standard film, digital, or video camera.
